(19) United States
(12) Patent Application Publication
(10) Pub. No.: US 2025/0021949 A1
(43) Pub. Date: Jan. 16, 2025

(54) Systems and Methods for Blockchain-Based Profiles and Names

(71) Applicant: Prem Makeig, Belfast, ME (US)

(72) Inventor: Prem Makeig, Belfast, ME (US)

(21) Appl. No.: 18/773,799

(22) Filed: Jul. 16, 2024

Related U.S. Application Data
(60) Provisional application No. 63/527,077, filed on Jul. 16, 2023.

(51) Int. Cl. G06Q 20/04

(52) U.S. Cl. CPC G06Q 20/04

(57) ABSTRACT

A solution for renting crypto domains is developed using a special type of smart contract called a renewal controller that is assigned to each crypto domain upon registration. In the system a crypto domain that is registered in blockchains is used as an alias for a crypto address where it is possible to assign a renewal controller to each name in such a way that it cannot be unassigned for the life of the name, e.g., until the name expires.

### CROSS-REFERENCE TO RELATED APPLICATIONS

This application claims the benefit of U.S. Provisional Patent Application No. 63/527,077, filed on Jul. 16, 2023, entitled “Systems and Methods for Blockchain-Based Profiles and Names,” the entire contents of which are incorporated herein by reference.

### FIELD OF INVENTION

The present invention relates to systems and methods for renting and managing crypto domains, also known as blockchain-based profiles and usernames. More specifically, it pertains to an extension of the Ethereum Name Service (ENS) protocol and the Name Wrapper smart contract, enabling the rental of crypto domains using a third-party-controlled renewal controller. The invention aims to address issues related to trust and pricing in domain name renewal, ensuring the secure and fair rental of crypto domains on the blockchain. Additionally, it introduces features such as subnames, token gating, gift certificates, and vouchers to enhance the usability and functionality of the ENS ecosystem. The system and methods outlined in this patent application provide a comprehensive solution for registering, managing, and renting crypto domains in a decentralized manner, facilitating their use as aliases for crypto addresses, websites, messaging handles, and user accounts for decentralized applications (Dapps) among other applications in the realm of Web3.

### BACKGROUND

Modern cryptocurrencies were born with the invention and subsequent rise in popularity of Bitcoin, and later with the invention of Ethereum. Ethereum extended the capabilities of Bitcoin by allowing a new type of account called smart contracts. Smart contracts allow for arbitrary code to be written that is public and available to anyone on the network. It is possible for anyone to interact with the code, and any successful transactions interacting with the code that modify the underlying state of the code are shared with all participants of the network. Ethereum has been described as a new type of computing platform, sometimes called a global state machine. In the Ethereum network, every user and smart contract has an Ethereum address, which is a 40-character hexadecimal number, e.g., 0x8b1f85a93Ac6E4F62695Ea8EF2410d248605FEff. Because of their complexity and length, addresses are not considered human-readable. To interact with smart contracts, users can use decentralized applications (Dapps), web applications that have special functionality to interact with a smart contract-based blockchain such as Ethereum. Another key component of Ethereum is wallets. Wallets that can interact with Dapps are often browser plugins or mobile phone apps, e.g., Metamask, that allow users to sign transactions using a secret private key. An Ethereum address is derived from the public key and is therefore public. This type of cryptography is called public-private key cryptography, and it is one of the key components of the Ethereum blockchain. As the development of Dapps has continued, many people believe that the internet will become more integrated with blockchain technology, which many call Web3, a third phase of the internet, wherein various cryptocurrencies and tokens are seamlessly traded, and monetary value can be sent across the internet just as easily as data has been traditionally. Recently, more and more Dapps and users have been using their Ethereum addresses as a form of identification, including Sign In With Ethereum (SIWE), which allows Dapp developers to forgo using a login and password and instead use an Ethereum address. However, Ethereum addresses are long and not very human-readable. To solve this problem, the Ethereum Name Service (ENS) was created to allow anyone to get a human-readable name that can be used instead of an Ethereum address. For example, Vitalik.eth is the name used by Vitalik Buterin, which is mapped to the address 0xd8dA6BF26964aF9D7eEd9e03E53415D37aA96045.

Recently, ENS has become more widely used, with currently over 1 million names registered. One of the features of ENS is the ability to create subnames, similar to subdomains. For example, slasha.vitalik.eth is a subname of vitalik.eth and it is used to publish a decentralized website built using IPFS, a peer-to-peer file-sharing network. The IPFS address is ipfs://bafybeig4ukd5x23zpe42hqneu6oztv52wybzarqsdz5o5iysuq5rocy6jm. The ENS protocol was recently upgraded to offer new features and capabilities, particularly for subnames, which were previously not NFTs (Non-Fungible Tokens) and could not be easily traded. Another key feature of the upgrade was to allow subnames to be easily owned by another party other than the parent name owner. A special “fuse” was created in a smart contract called the Name Wrapper, which allows a parent name owner, i.e., vitalik.eth, to “emancipate,” or make independent, a subname, such that the subname can be transferred to and controlled by another owner, other than the owner of the parent name. A fuse is a type of switch that can be “burned” or switched only once in a smart contract. For example, in the case of emancipated names, the fuse in the Name Wrapper smart contract is called PARENT_CANNOT_CONTROL, and once it is burned, the owner of the subname, e.g., slasha.vitalik.eth, can control the subname independently of the parent name, e.g., vitalik.eth. Another feature of the Name Wrapper is that all subnames that have been emancipated also have an expiration date. If the parent name owner wants to sell the subname in a way that the new owner is able to renew their name indefinitely without a fee, then an additional fuse CAN_EXTEND_EXPIRY can be burned, to allow for what can be called “forever names,” or subnames that can be owned outright by an owner independently of the parent name owner, and which can be renewed indefinitely without a fee. It is still necessary for the parent name owner to renew their name and pay the fee to ENS, but currently with the ENS protocol, the renewal of the second-level parent name, e.g., vitalik.eth, can be paid by anyone, so the subname owner is equally able to pay the renewal fee, and thus control and own their subname independently of the owner of the parent name.

The Name Wrapper smart contract also allows for subname rentals using a special approved “renewal manager,” which is a smart contract approved to renew subnames, such as tim.web.eth, of the parent-level name, e.g., web.eth. The renewal manager can also be locked by burning a special fuse, CANNOT_APPROVE, into the parent-level name, e.g., web.eth. After the CANNOT_APPROVE fuse is burned, the renewal manager contract can never be updated or changed again. Burning a fuse on the parent-level name introduces several significant downsides, including the possibility that there is a bug in a renewal manager that has been locked on the parent-level name, making it impossible to ever resolve the issue. Even if there is not a bug found in the contract, over time the contract may become outdated and need to be upgraded, but with the fuse CANNOT_APPROVE burned, it is not possible to upgrade the renewal manager. It may be possible to create an upgradeable smart contract and, in some cases, avoid the “tech lock-in” problem, but over time the standards for upgradeable smart contracts are also likely to change, meaning that even an upgradeable smart contract can become outdated technology.

The Ethereum Name Service (ENS) is a decentralized domain name system built on the Ethereum blockchain. It serves as a decentralized equivalent to the traditional Domain Name System (DNS) used on the internet. ENS allows users to register and manage domain names ending in .eth, which can be used to resolve addresses for various resources on the Ethereum network, such as cryptocurrency wallets, decentralized websites, and decentralized applications (dApps). At the core of ENS is a master registry, which acts as the authoritative record for all .eth names and their subdomains. This master registry, built using a smart contract on the Ethereum blockchain, provides an immutable and tamper-proof system for registering and managing domain names. The smart contracts used by ENS are decentralized and operate based on predefined rules, making them resistant to censorship and manipulation.

ENS operates by mapping human-readable domain names to Ethereum addresses and other resource identifiers. It provides a user-friendly and memorable way to interact with the Ethereum ecosystem, as users can access services and send transactions using simple and recognizable names instead of long, complex hexadecimal addresses. ENS domain names can also support additional features like subdomains and text records, enabling developers to create personalized websites and dApps with decentralized content hosting.

ENS, with its master registry built on immutable smart contracts, offers several benefits over traditional domain systems. The decentralized and immutable nature of smart contracts ensures that once a domain name is registered, its ownership cannot be altered or revoked without the owner's consent. This provides a high level of security and trust in the ENS system. Additionally, ENS supports integration with wallets and applications, making it easier for users to send and receive transactions securely.

Some of the key components of the ENS protocol include:

Registrar: The Registrar smart contract handles the registration and management of domain names within the Ethereum Name Service (ENS) system. It ensures the uniqueness of domain names and enforces rules for registration, renewal, and expiration. The Registrar contract also manages the auction process for premium domain names. Users bid for exclusive rights to a particular domain, and the Registrar determines the winner based on the bidding mechanism.

Resolver: The Resolver contract maps domain names to Ethereum addresses or other resource identifiers. It acts as a lookup mechanism, providing the necessary information to resolve a domain name to its associated resource. The Resolver contract allows users to update and manage the records associated with their domain names, such as setting the Ethereum address for receiving funds or specifying the IPFS hash for decentralized content hosting.

Reverse Registrar: The Reverse Registrar contract enables the registration of Ethereum addresses mapped to ENS domain names. Users can associate their Ethereum addresses with human-readable domain names ending in .eth. This feature provides a user-friendly identity which can be used with Dapps to identify a wallet used by a user, allowing for social interactions, and custom profiles to be generated based on the primary ENS name of the user. This includes text records, which may include links to social media handles and an avatar record. It is also possible to include site preferences as ENS text records, for example, a preference for light mode or dark mode, as well as a language preference, or just about any other preference which can be saved in a key-value text record pair.

ENS Registry: The ENS Registry contract acts as the master registry for all .eth names and their associated subdomains. It serves as the authoritative record for domain name ownership and facilitates the interaction between the Registrar, Resolver, Reverse Registrar, and other contracts. The ENS Registry contract maintains the ownership records of .eth names on the Ethereum blockchain, ensuring the integrity and immutability of the domain name system. It is also possible to have DNS records saved in the ENS Registry for example ensname.com, but the ultimate ownership of a DNS name is generally not saved in the ENS registry, but instead is saved in the DNS registry of the top-level domain, such as .com. It is, however, possible to create a DNS registry that uses the ENS registry as the method for storing domains and their respective owners.

NameWrapper: The NameWrapper is a smart contract that plays a crucial role in the ENS ecosystem. One of the key features of the NameWrapper is to simplify the management and transfer of subnames by encapsulating them within ERC-1155 NFTs, making it easier for users to interact with and trade their subnames. The NameWrapper also has a “fuse” system that allows for fine-grained control over how an ENS name can be used, including means for “emancipating” or severing the ownership of a subname from the parent owner, allowing for another owner to own the subname independently of the parent name owner. It is also possible to burn fuses that restrict the use of an ENS name in various ways, including disabling the creation of subnames, editing of the resolver, or even burning any additional fuses.

It is also possible to use Zero Knowledge Proofs (ZKP) with ENS blockchain-based profiles and usernames. ZKPs have several important properties, including the ability to cryptographically prove any computation, as well as the ability to prove assertions about data without revealing all the data. This privacy-preserving capability allows for ZKPs to be used with blockchain-based ENS names, profiles, and usernames. For example, a user can prove something about themselves without revealing the underlying data, such as proving that their age is over 18 without disclosing their exact age.

Traditionally, it was necessary for programmers to write custom circuits for ZKP, where every new application required them to create a new custom set of circuits, and any changes to the application would require re-coding the custom circuits. More recently, it is possible to prove entire low-level virtual machines (VM), including RISC-V, x86, MIPS, and WASM (WebAssembly). These types of ZKPs are called ZKVMs, which make it possible to prove both the computation of any arbitrary code that can be compiled down to the VM. For example, a Rust program can be compiled down to RISC-V byte code.

The integration of ZKPs with ENS names can enable several innovative use cases. Private Attribute Verification allows users to prove specific attributes (e.g., age, residency) without revealing personal information. This can be especially useful for age-restricted services or verifying residency for region-specific services. Selective Disclosure lets users selectively disclose certain information about their ENS profile. For instance, an ENS name might be associated with multiple attributes, but the user can choose to reveal only the necessary attributes for a specific interaction. Anonymous Voting can be facilitated within DAOs associated with ENS names, where members can prove their eligibility and submit their vote without revealing their identity. Secure Authentication enables users to authenticate themselves to a service using their ENS name without exposing sensitive data, enhancing security and privacy, especially in decentralized applications. Regulatory Compliance can be achieved with ENS names in a manner compliant with regulations like KYC/AML without compromising user privacy. ZKPs can verify compliance while keeping user data confidential.

These capabilities of ZKPs enhance the utility and security of ENS names, profiles, and usernames, making them more versatile and user-friendly in various applications. In the context of ENS, the resolver is the definitive source of information that is resolved for an ENS name. In many cases, multiple ENS names owned by different owners all resolve to a common resolver, such as the Public Resolver currently used with the ENS protocol. However, it is also possible to have a resolver, which can be one or more smart contracts, owned by a single owner. This allows for a wide variety of resolver types and configurations to be used by different owners.

An owned resolver can be thought of as the single source of information or profile about a single owner, which can be an organization as well as an individual. Owned resolvers provide more customization and configuration options over standard resolvers, such as the Public Resolver. They resolve information including blockchain addresses, text records, avatar records, and more. These owned resolvers allow different owners to have their unique resolvers, as well as facilitate easy upgrading and extending of the resolver based on the owner's needs.

### SUMMARY

A solution for renting crypto domains is proposed using a special type of smart contract called a renewal controller that is assigned to each crypto domain upon registration. Traditionally, a single parent-level controller smart contract is used to renew all subdomains of the parent-level domain, which can also be the top-level domain, i.e., .eth, in the case of vitalik.eth. It has also been possible to assign a single parent-level renewal controller on a second-level domain, e.g., web.eth, that can be used to renew third-level names, e.g., sam.web.eth. The system we propose makes it possible to assign a renewal controller to each name, which can also be assigned in such a way that it cannot be unassigned for the life of the name, e.g., until the name expires.

Crypto domains are domains that are registered using blockchains. They also have the ability to be used as an alias for a crypto address, for example, an Ethereum address such as 0x8b1f85a93Ac6E4F62695Ea8EF2410d248605FEff. They can also be used for websites, messaging handles, and user accounts for Dapps among many other uses of naming on the internet.

One of the key benefits of having a renewal controller with the ability to renew a crypto domain is that it can solve the problem of the renter of the domain needing to trust the owner of the parent-level domain to allow them to renew the name at a reasonable price. Traditionally, it has been possible for the parent-level name owner, .eth, in the case of vitalik.eth, to change the renewal price at any time FIG. 10. The second-level domain owner, e.g., Vitalik.eth, needs to trust that the parent-level domain owner, e.g., .eth, will not unreasonably raise the price of renewing the name. With our system, it is possible to give the responsibility of renewing the name to a third party that is neither the parent-level name owner nor the renter, such that the renter of the domain doesn't need to trust the parent-level name owner, e.g., .eth or web.eth, to renew their name at a reasonable price.

Our system extends the capabilities of the ENS protocol and specifically in one embodiment the Name Wrapper smart contract to allow for crypto domains, also called names or subnames, to be rented using a third-party-controlled renewal controller smart contract. To register names or subnames using our system, a user will enter the name into a search query in our Dapp. It is also possible to request to register a name from a chatbot or directly using a wallet app. The user will then be informed if the name is available or not, and given a number of different suggestions of available names, including subnames (e.g., name.web3.eth) or alternatives (e.g., name776.eth). Each name can also have a price to register the name as well as a price to renew the name, which may be different. Promotions or discounts may be available, and in some cases, the cost of registering the name is free. Usually, there will still be a fee paid to the blockchain network, called a gas fee, to do the registration on-chain.

After the user inputs the name they want to register, several checks take place to ensure the name is available for registration. These checks may include verifying the registry smart contract, ensuring the parent name is offering subnames for rent using the system, and confirming the necessary smart contract approvals have been made by the parent name owner. If the name is available for rent, the user can register the name by clicking on a registration button or indicating an interest in registering a name through a text or voice-based chatbot or virtual assistant. The user can also specify the duration they want to register the name for, e.g., one year, as well as the currency or token they want to use to pay the fee and any gas fees.

In some cases, a two-step process is used. First, the user claims the name using a secret, which can be a number or phrase, hashed together with the name, and submits that claim as a blockchain signature. After making the claim transaction, the user can register the name using the secret. This two-step process combats a security issue called front running, where an attacker learns the user's intent to register a name and registers it first by paying a higher gas price. When the name is registered, our system ensures that the name is “unruggable,” meaning that the renter can retain the name for as long as they want and that the renewal price will not be unreasonably raised, effectively revoking the name from the renter.

In the case where the name is a subname of a .eth ENS name, e.g., name.web3.eth, a special smart contract called the Subname Wrapper can be used. The Subname Wrapper has a record of the latest ENS Name Wrapper smart contract, which can be used to register subnames of the parent name, e.g., web3.eth. The parent name owner has also approved the Subname Wrapper, a special function of smart contracts, to allow the Subname Wrapper to register subnames on the owner's behalf. In addition to the Subname Wrapper, a Subname Registrar contract can be used, which the parent name owner has also approved, containing the functionality required to register subnames using the Subname Wrapper. The Subname Registrar has several configurations set by the parent name owner, including a registration price (in ETH or other cryptocurrencies or tokens), a minimum duration (the minimum amount of time the name can be rented), a maximum duration, and the renewal price, defined by a special smart contract called a Renewal Controller selected by the parent name owner for registrations. It is also possible to have various registration conditions and configurations, including different prices for each subname (e.g., 1 ETH for john.smith.eth and 0.5 ETH for pedro.smith.eth) and special discounts or token gating. Token gating restricts access to something, like a discount, based on a token held in the user's wallet, which could be an NFT, a ticket, or a membership badge. It could also be an ENS name or subname (e.g., name.somedao.eth). Since the registrar responsible for registering subnames is a smart contract, any kind of programmatic logic is possible, and any on-chain data sources can be used for that logic, such as a user's balance of a particular token, e.g., ENS tokens.

The user interface, which can be a web application or website, a mobile application, a virtual assistant application, or virtual reality (including AR, VR, or XR applications), or any other type of app interacting directly with the user to register names, can have any number of requirements for registering a name, including payments using credit cards, off-chain tokens, rewards points, or credits. It is also possible to redeem a gift certificate, including vouchers created using a cryptographic signature. When a subname is gifted to another user, the gift giver can create a special voucher using public and private key cryptography. The voucher authorizes using the gift giver's funds for registering the gifted name and is signed using the gift giver's private key. When the gift receiver wants to use the voucher to register their gifted name, they can use the voucher instead of paying the fees, including at least one of registration fees and gas fees. When the voucher is used, the signed cryptographic message can be submitted to the registrar smart contract for verification. It might also be necessary for the gift giver to authorize the registrar contract to transfer funds from their account, a common requirement on blockchains like Ethereum when authorizing token transfers, for example, ERC-20 token transfers. A voucher system can also be used to “airdrop” or gift free names to a list of users. The owner of a parent name, for example, could create a list of recipients to receive free subnames. Each user on the list could receive a voucher containing a cryptographic signature, allowing them to redeem a subname without paying any registration fees. Another method for airdropping subnames could use a Merkle tree, which takes a list of data (in this case, the wallet address and subnames to be gifted) and hashes the list many times into a single root hash. When the airdrop recipient claims their name, they use a proof that cryptographically proves their wallet address is on the list, and they have been assigned a subname or are allowed to register a subname using their Merkle tree proof.

Currently, there is a push by the blockchain industry to move away from Externally Owned Accounts (EOA) in favor of smart accounts, which allow an unlimited number of features to be added and used. In a recently proposed EIP (Ethereum Improvement Proposal), ERC-4337 was proposed, which establishes a standard for smart accounts, also called account abstraction. Smart accounts are smart contract-based and have the ability to hold cryptocurrency as well as token balances that are controlled by the user(s) of the wallet. Smart wallets are smart contracts deployed to a blockchain, for example, the Ethereum blockchain. Some of the features that can be implemented with smart accounts include gas abstraction using paymasters, wherein the gas, or blockchain fee, necessary for transactions can be paid by a third party. From the user's perspective, the cost of using a blockchain can be abstracted away, so sending a token, for example, will not have an associated fee, or it could be possible to have the fee paid in the token being sent instead of the native currency, e.g., ETH, which is traditionally necessary to pay gas. It is also possible to create safeguards where a user can self-limit the uses of their wallet to well-known apps and payments only to known contacts. If the user wants to make a payment or use an app that is not on their safe list, they would need to sign a message, for example, saying that they are aware of potentially unsafe transactions. This is similar to what credit card companies do, where they either block certain transactions or require the cardholder to sign off on certain transactions using a text message. It is also possible to have an account recovery feature where, if the user loses their account credentials, whether a private key, passphrase, passkey, or security hardware device, they can request a predefined set of guardians to allow them to access their account. The guardians can include family members, trusted companies, employers, or other entities that the user trusts to recover their account.

Using our system, it is possible to receive a smart wallet that by default has an ENS name associated with it. It would also be possible to receive an “unruggable” ENS name with only a signature or “click” if the user is logged in and verified, and where the gas required to register the name is abstracted away from the user, making the process of setting up the wallet with an ENS name seamless and without requiring any fee. This is possible because the user might already be paying a monthly fee to a company that will sponsor the transaction, similar to bank accounts where the funds deposited in the account are invested to cover the cost of the account. It is also possible for the sponsor of the transaction to make money from the funds deposited by the user, for example by staking the user's cryptocurrency, such as staking ETH or converting ETH into a liquid staking token, e.g., rETH.

Once a user has their wallet set up and an ENS name using our system, e.g., an “unruggable” subname, it is possible to share the name for anyone to send cryptocurrencies or tokens to their wallet using their ENS name, i.e., jen.x-wallet.eth. From the user's perspective, the process of getting a wallet and sending funds to other wallets is as easy as sending an email or text message. The user can completely avoid seeing any long blockchain “0x” addresses, e.g., 0x8b1f85a93Ac6E4F62695Ea8EF2410d248605FEff, and their smart wallet just works, allowing them to deposit money (i.e., tokens or crypto), send money, and interact with Dapps.

The wallet also serves as their de facto identity when they use Dapps, for example, social Dapps, where the list of followers for each user is saved on a blockchain, and anyone can create a Dapp that uses the shared social “graph” or the list of all the followers of all the users. A feature of the ENS protocol called primary names can be used, where the wallet address has the name, for example, jen.x-wallet.eth, set as its primary name. This name can then be used by Dapps when the smart wallet is used to log in or connect to the Dapp.

Web3 social media is revolutionizing online identity by placing users in control of their personal information. With the use of blockchain technology, individuals can create a blockchain-based profile or “poster” (FIG. 6) that reflects their desired identity, complete with an avatar 65 and preferred blockchain name 60.

This shift towards user-controlled identity brings about a range of advantages. Unlike traditional social media platforms where users often have limited control over their profiles, Web3 social media allows individuals to truly own and manage their online identity. They can curate their profiles, choose the information they want to share, and present themselves in a way that aligns with their preferences and values.

The blockchain-based profile serves as a digital representation of the user, which can be authenticated and verified through cryptographic methods. This adds an extra layer of trust and security to the user's online identity. By utilizing decentralized identifiers (DIDs) and digital signatures, users can establish their unique identity in a tamper-proof and censorship-resistant manner.

Furthermore, the avatar and preferred blockchain name 60, also called the primary name, associated with the blockchain-based profile enable users to express their individuality and creativity. They have the freedom to choose an avatar 65 that represents them visually, whether it's a custom illustration, a photo, or an animated character using AI. Likewise, users can select a preferred blockchain 60 name that resonates with their personal brand or online persona.

Within this evolving landscape, blockchain-based user profiles 64 have emerged as a powerful tool for enhancing user identity and data management. These profiles leverage the decentralized and transparent nature of blockchain technology to empower users with ownership and control over their digital identities and personal data. By utilizing cryptographic keys and smart contracts, blockchain-based user profiles provide secure authentication and authorization mechanisms, ensuring trust and privacy. These profiles store a comprehensive range of user attributes, including biographical information, encrypted biometric data, preferences, achievements, and virtual assets. The utilization of blockchain-based user profiles in Metaverse applications enables seamless interoperability, personalized experiences, and unified user interactions across various virtual worlds and applications. Metaverse applications refer to immersive virtual environments that integrate augmented reality (AR), virtual reality (VR), and other emerging technologies to create a shared digital realm. Moreover, these profiles hold the potential to empower users with the ability to monetize their data and participate in the emerging economy of the Metaverse.

Blockchain-based profiles can revolutionize mobile phone interactions, including iPhones, allowing users to securely share profiles through proximity-based actions, as well as communicate between profiles using messaging 62 and voice calls 63. Using features like NFC or Bluetooth, individuals can effortlessly exchange profiles by bumping phones or bringing them close together. This approach ensures privacy, security, and user control over personal information. With immutable records, the blockchain guarantees transparency in profile sharing. By integrating blockchain-based profiles 64 into phones, users experience simplified, connected interactions, enabling seamless profile sharing for networking, socializing, and collaboration. It is also possible to make payments in this way using smart wallets, using NFC or Bluetooth, where one profile sends money to another profile. The sender can authorize the transaction with one or two clicks or with a voice-activated command. It is also possible for the receiver to make a payment request and then all the sender needs to do is move their phone close to the receiver's phone, and the payment of tokens or cryptocurrency is made without the sender needing to click any buttons or take any additional actions.

Blockchain-based user profiles offer a robust solution for companies seeking secure access control to their proprietary software and physical infrastructure, such as data centers. Leveraging the decentralized and tamper-resistant nature of blockchain technology, companies can establish reliable user profiles as verifiable digital identities. These profiles securely store user credentials, permissions, and access rights while ensuring privacy through built-in features like zero-knowledge proofs (ZKPs). With ZKPs, the authenticity of sensitive information can be verified without disclosing the actual data, preserving privacy during access control processes. Furthermore, blockchain-based user profiles can include the storage of cryptographically secured biometric data, which can be proven using ZKPs. This allows for enhanced identity verification through biometric authentication methods such as fingerprints, iris scans, or facial recognition, ensuring a higher level of security for access to proprietary software and physical infrastructure. By incorporating blockchain-based user profiles, companies can enforce granular access control mechanisms, strengthen security measures, and maintain control over their valuable assets. The immutability and traceability provided by the blockchain's audit trail and ZKPs enhance accountability and facilitate compliance with regulatory requirements. This comprehensive solution empowers companies to establish privacy-preserving and secure access management systems for their proprietary software and physical infrastructure.

### BRIEF DESCRIPTION OF DRAWINGS

FIG. 1 shows a Dapp interface view of the present invention.

FIG. 2 shows a Dapp interface view of the present invention.

FIG. 3 shows a Dapp interface view of the present invention.

FIG. 4 shows a Dapp interface view of the present invention.

FIG. 5 shows a Dapp interface view of the present invention.

FIG. 6 shows a poster view of a mobile phone with a blockchain domain.

FIG. 7 shows a poster, i.e. call screen, view of a mobile phone with a blockchain domain.

FIG. 8 shows a series of steps to create and renew a subname using a renewal controller.

FIG. 9 shows a diagram of the resolver hooks-based system.

FIG. 10 shows a diagram of “Ruggable Rentals,” wherein the owner of the parent name of a domain can take back or block the subname owner from renewing the name.

FIG. 11 shows a diagram of “Unruggable Rentals,” wherein the owner of the parent name of a domain cannot take back or block the subname owner from renewing the name.

FIG. 12 shows a diagram of the relationship between the parent name owner, subname owner, and a third party that controls the renewal of a subdomain.

### DETAILED DESCRIPTION

With our system, it is possible to create a streamlined user experience where users can create a blockchain-based wallet and profile with a name of their choosing that is “unruggable.” Users can keep their name as long as they like, provided the conditions for the rental are met, such as timely renewal payments, ensuring that no one else can have the same name. Our system builds upon a foundation of protocols and standards, including ENS, Smart accounts (e.g., ERC-4337), and NFTs (e.g., ERC-1155). To clarify the various features and components of our methods and system, we will detail each part starting with the core of what makes it possible to offer “unruggable” names: the contract that attaches renewal controllers to ENS names, such as the Subname Wrapper. While there are many ways our design can be implemented, we will detail various embodiments using the Subname Wrapper smart contract to clearly show how our system can work.

The Subname Wrapper smart contract is an ERC-1155 NFT smart contract configured to have non-fungible 1-of-1 tokens, with each token representing a subname. Each subname is a unique name under a parent name, such as mike.space.eth. To create a unique token, the full name is hashed using a special hashing algorithm used in the ENS protocol called a namehash. The namehash algorithm recursively hashes together the levels of the name (e.g., mike, space, and eth) using a Keccak-256 hash to create the final namehash. The namehash is a 32-byte number that is used as the token ID for each name in the Subname Wrapper smart contract. For a name to be wrapped in the Subname Wrapper smart contract, the owner of the parent name, e.g., space.eth, needs to authorize the Subname Wrapper smart contract to set the owners of subnames in the Name Wrapper smart contract. When an “unruggable” name is registered, the name is first created in the ENS Name Wrapper smart contract (e.g., using the setSubnodeOwner function), and the owner of the name is set to the address of the Subname Wrapper smart contract. Then, the token of that name is minted in the Subname Wrapper smart contract, and the final owner of the name is set as the owner of the ERC-1155 token in the Subname Wrapper. This process is called wrapping because the ownership is passed from the Name Wrapper to the Subname Wrapper smart contract. Along with the name, a “renewal controller” is saved with each name in the Subname Wrapper. A renewal controller is a smart contract that has been authorized and enabled, for example by the parent name owner, to renew the subname.

To enable users to get a subname using a Dapp, a registrar contract is used, called the Subname Registrar. The Subname Registrar can be approved by a parent-level name owner, e.g., space.eth, to allow the registrar to register subnames. The parent name owner can also input parameters such as the price of registering subnames, the minimum duration, maximum duration, and the cost of renewing subnames specified by choosing a renewal controller. For the subnames to be “unruggable,” the renewal controller is controlled by a third party FIG. 11 other than the parent name owner. The third party can be a dedicated organization responsible for maintaining the renewal price in the long term 110. In an example case, the renewal controller sets the renewal price of the subname at $5/year. The renewal controller is owned by a set of “guardians,” a group of people who act as wallet signers, responsible for maintaining the price. For this example, the guardians are trusted to keep the renewal price the same as the price of a five-character ENS name, currently $5. The renewal controller, in this case, is called the Five Dollar Renewal Controller ($5 Renewal Controller). The guardians of the $5 Renewal Controller use a multi-signature wallet (multisig) to collectively control the $5 Renewal Controller. If changes need to be made to the renewal price, for example, if the ENS DAO changes the price of five-character .eth second-level ENS names, currently $5/year, then the renewal price of the $5 Renewal Controller would also be changed to match the ENS DAO pricing. It is not possible for a smart contract to be directly linked to the ENS DAO's registrar contract to get the renewal price for the long term because there is no guarantee that the ENS DAO will not abandon their current registrar in favor of a new registrar, which could have an entirely different renewal price.

Another responsibility of the guardians is to ensure that any oracles used in the renewal controller are maintained. A persistent problem in the web3 economy is the issue of outdated, faulty, or malicious oracle data. It is not possible to completely rely on oracle data long-term. If the oracle dies or is manipulated, a new oracle must be found, or manipulated data must be blocked. For this example case, the oracle provides the price of ETH in terms of USD. This is used to convert the price of a renewal in ETH from the base price set in USD. Oracles are smart contracts that are continually updated to provide reliable off-chain data on-chain. If the oracle is not updated for any reason, the guardians need to find a new oracle.

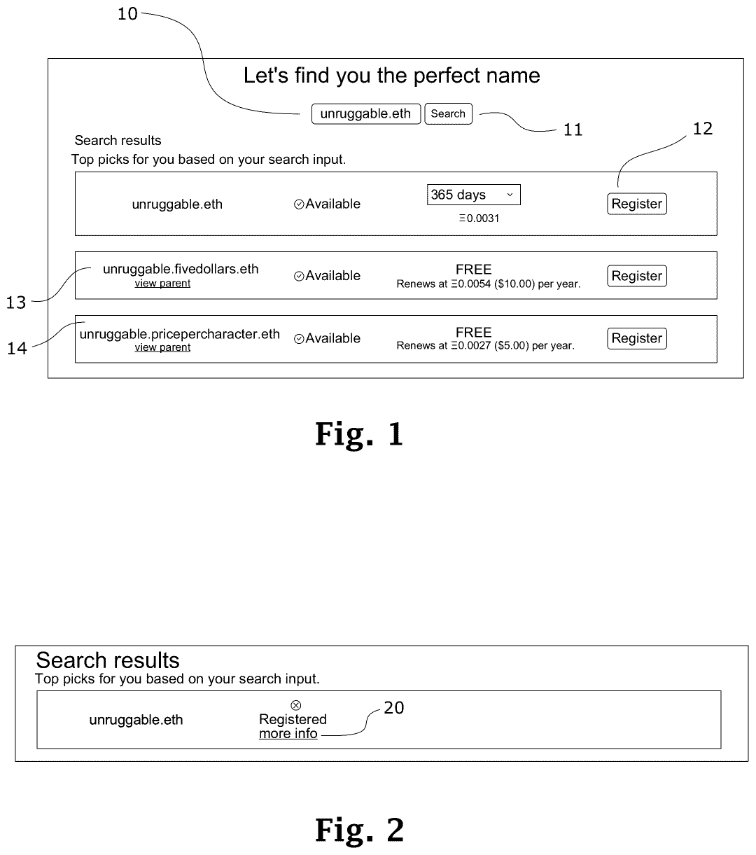

To give a more detailed example of how our system can be used, the following will be a step-by-step explanation (FIG. 1) of how it can be used for a Dapp.

### Registering a Second Level .eth Name:

1. Visit the Dapp.
2. Enter a name in the search box 10.
3. Click ‘Search’ 11.
4. Click ‘Register’ (assuming the name is available) 12.
5. You will be prompted to submit a commitment transaction using your wallet provider (e.g., Metamask).
6. If you have not connected a wallet, click ‘Connect’ in the bottom right-hand corner.
7. You will then be asked to confirm a second transaction to complete the registration of the name.

Note: We will display additional subname suggestions which demonstrate the two initial renewal controllers that we have developed: $5 Renewal Controller 13; and a Length Based Renewal Controller 14.

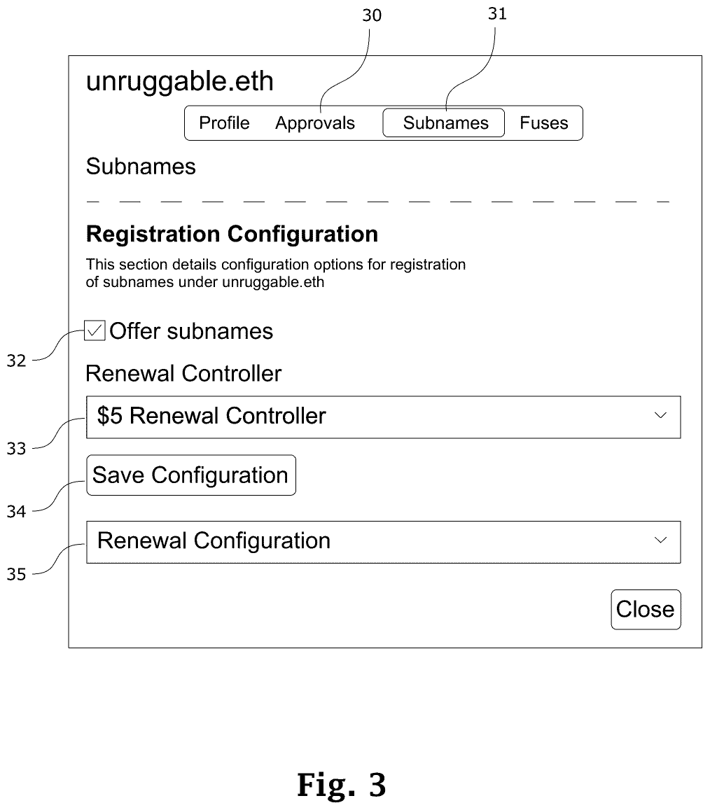

### Setting Up Subdomain Registrations for Your Second Level .eth Name FIG. 2, and FIG. 3.

1. Click on ‘more info’ 20.
2. Click on the ‘Approvals’ tab 30 (this is only shown for names owned by your connected address) to provide necessary approvals for our smart contracts to interact.
3. Approve the necessary contracts:
   Allow our SubnameWrapper contract to control your parent ENS name (e.g., forsubs.eth) within the ENS NameWrapper contract.
   Allow our SubnameRegistrar contract to register subnames of your parent ENS name, e.g., name.forsubs.eth, in the SubnameWrapper contract.
   Note: It is possible to un-approve these contracts at any time, effectively revoking the offering of subnames for rent on a parent-level name.
4. Click on the ‘Subnames’ tab 31 and select ‘Registration Configuration’.
5. Toggle the ‘Offer subnames’ checkbox 32.
6. Choose a renewal controller from the dropdown menu 33 (currently the $5 Renewal Controller and the Length Based Renewal Controller are available).
7. Click ‘Save Configuration’ 34.

Subnames of your parent name can now be registered!

Note: It is possible to change these settings at any time, effectively allowing for turning off renting subnames or changing to a different Renewal Controller at any time. Currently, the subname registrar offers free registration of all subnames for the first year. We are working on additional registration options, including airdrop functionality and individual pricing per name. After the first year, renewal costs are subject to the rules set out in the selected Renewal Controller. You can review the rules defined by the renewal controller by clicking the ‘Renewal Configuration’ section 35.

### Registering a Subname

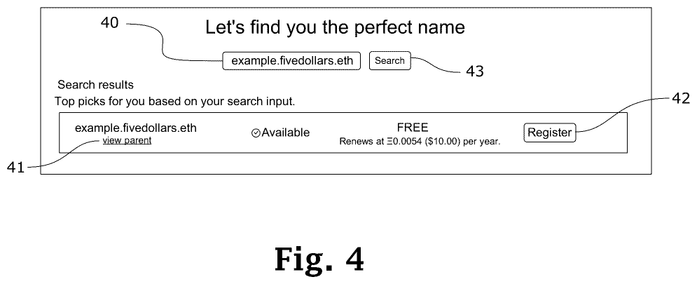

The process for registering a subname FIG. 4 is the same as outlined above for a second-level .eth name:
1. Enter a subname of the name you registered and set up 40 (following the previous steps).
2. Click the ‘Register’ button 41 and proceed as above.

### Renewals

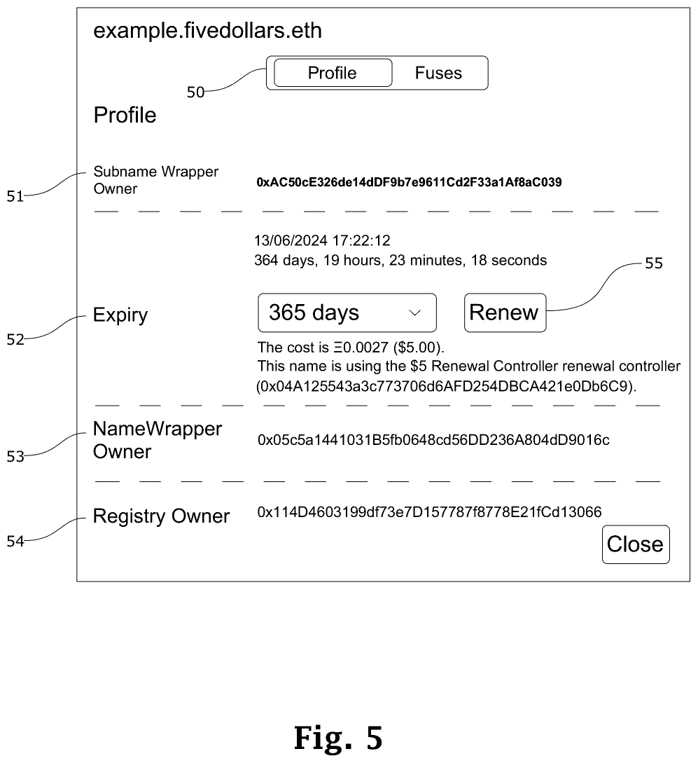

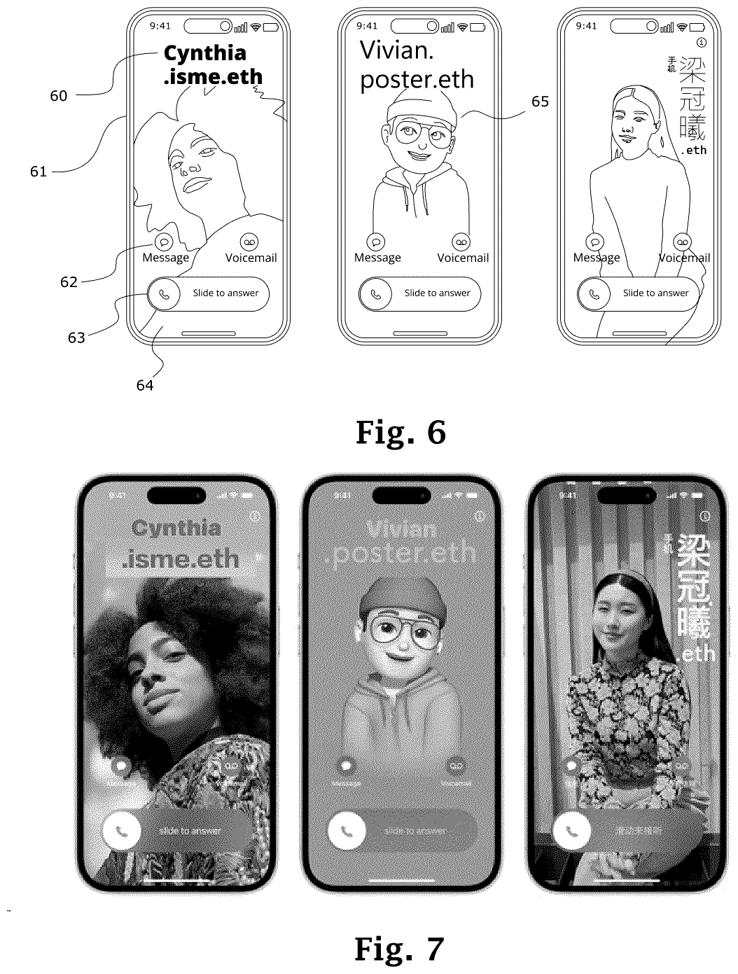

It is possible to renew subnames using the Dapp interface, FIG. 5. The Renew button 50 can be found in the ‘more info’ 20 tab of any name/subname. Renewals for second-level names are routed through the normal ENS .eth registrar controller and are subject to its pricing rules. Renewals for subnames are subject to the rules outlined in the specific Renewal Controller associated with the subname.
The $5 Renewal Controller will charge a set price of $5 per year for renewals.
The Length Based Renewal Controller charges $1,000 for 1 character names, $100 for 2 character names, $10 for 3 character names, and $5 for all other names.

### Using Smart Accounts and AI

The previous examples of how to register a second-level .eth name, set up subdomain registrations for second-level .eth names, register subnames, and renew subnames are shown using the typical method of connecting a crypto browser extension wallet, such as Metamask, to a Dapp website running in a browser, like Google Chrome. However, it is possible to reduce the number of steps using a smart wallet, such as ERC-4337, where it is possible to set up a smart wallet at the same time as registering an ENS second-level name or subname using only one or two clicks.

It is also possible to set up and use a smart wallet with a chatbot, such as an AI virtual assistant. The user can simply tell the chatbot, either through a voice command or by typing, that they want to set up a wallet with a name. The wallet can be a smart wallet, and the name can be an ENS second-level or third-level subdomain. The chatbot can ask the user what name they want, and then the AI chatbot can complete the necessary steps, similar to those previously shown, on behalf of the user. It is also possible to combine chatbots and user interfaces to present the user with a list of available names if the desired name is not available. In this case, the AI could decide which alternative names to present based on factors such as nicknames or personal information of the user, like their city, state, or country.

For example:
Mike.eth—Not available
Michael.USA.eth—Not available
Mike.isme.eth—Available
Mike.240.eth—Available

If the user likes one of the names, they can simply click on the name or indicate with a voice response which name they want.

For the owner of a name, such as site.eth, it is also possible to use an AI virtual assistant to offer subnames for rent or sale using some or all of the steps shown above. This may include burning fuses in the ENS NameWrapper smart contract, configuring a registrar, making smart contract approvals, and selecting a Renewal Controller. It should be noted that anything that can be done by a wallet, Dapp, or a user can also be done by an intelligent AI agent or chatbot. It is also possible to use a chatbot in combination with a head-mounted display (HMD), such as a VR/AR/XR device.

### Smart Contract Functions and Steps

The previous example showed how an end-user might interact with our system. Next, it will be shown how the smart contracts can be configured and the transactions and calls that allow our system to offer “unruggable” name rentals.

### Setting up a Second Level .eth Name for Rentals

Register and wrap the second-level name, e.g., site.eth, in the NameWrapper smart contract.

nameWrapper.registerAndWrapETH2LD(

| | |
|---|---|
| “site”, | // The name to register, i.e., site.eth. |
| account, | // The owners account |

```
  twoYears,
  address(publicResolver),
  uint16(CANNOT_UNWRAP) // Burn the CANNOT_UNWRAP fuse.
  );
```

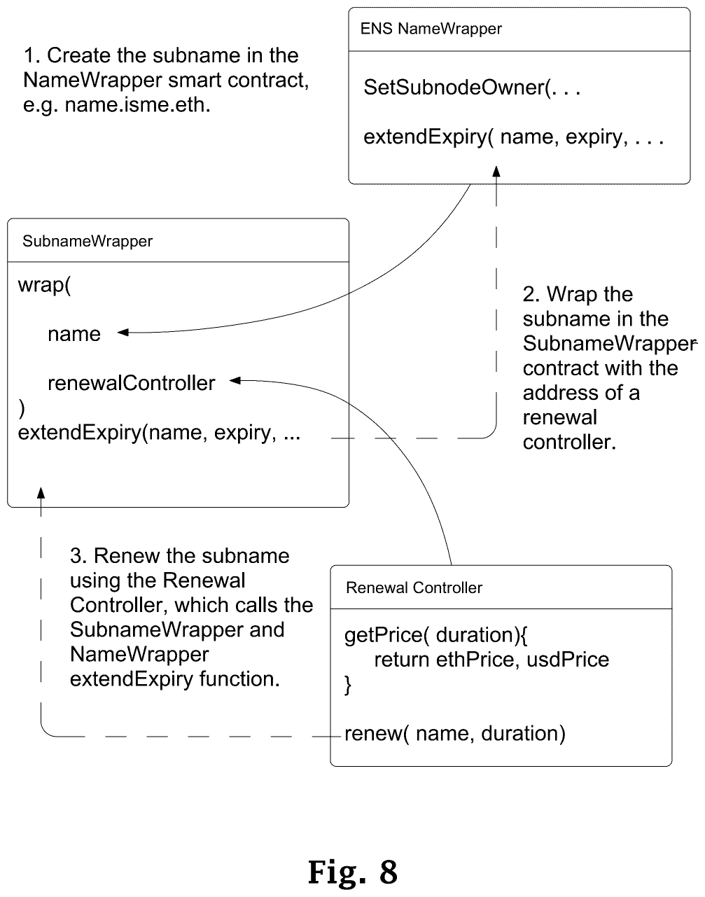

In order to register subnames using the subname wrapper FIG. 8, the owner of the parent name needs to approve all for the Subname Wrapper in the name wrapper.
nameWrapper.setApprovalForAll(address(subnameWrapper), true);

For the name site.eth to begin offering subnames for rent, the registrar needs to be set up, including allowing the offering of subnames.

```
// Set the registration parameters for subnames of the parent name.
subnameRegistrar.setParams(
  parentNode,
  true, // allow registering of subnames
  IRenewalController(address(renewalController)),
  3600, // minimum registration duration
  31536000, // max registration duration in seconds
  1, // minimum number of characters
  255 // maximum number of characters
  );
```

Approve the Subname Registrar to allow subnames to be created by it on our behalf.
subnameWrapper.setApprovalForAll(address(subnameRegistrar), true);

Using the code above, the name site.eth is now set up for registering subnames using our system.

Registering a Third Level (subname) .eth Name for Rentals

Create a commitment for the subname registration for my.site.eth.

```
  bytes32 commitment = subnameRegistrar.makeCommitment(
  “\x02my\x04site\x03eth\x00”, // The name my.site.eth in DNS format.
  account, // The owner of the subname.
  bytes32(uint256(0x4453)) // This is the secret.
  );
// Submit the commitment.
subnameRegistrar.commit(commitment);
// Wait 60 seconds
// Register the subname, and overpay with 1 ETH.
// Over payment amounts are refunded,
  subnameRegistrar.register{value: 1000000000000000000}{
  “\x02my\x04site\x03eth\x00”,
  account,
  referrerAccount,
  oneYear,
  bytes32(uint256(0x4453)), // The secret.
  address(publicResolver),
  0 /* no additional fuses burned */
  );
```

In the register function of the Subname Registrar, there is a call to the Subname Wrapper, FIG. 8, to register and wrap the name in the Subname Wrapper.

```
    subnameWrapper.registerAndWrap(
  Name, // my.site.eth
  owner,
  resolver,
  fuses | CANNOT_UNWRAP | PARENT_CANNOT_CONTROL | CAN_EXTEND_EXPIRY,
  expires,
  pricingData[parentNode].renewalController
);
```

In the SubnameWrapper ‘registerAndWrap’ function, there is a call to the NameWrapper to wrap the subname in the NameWrapper and set the owner to the SubnameWrapper.

```
  // Wrap the name by setting the owner in the name wrapper
  // to this contract address.
  nameWrapper.setSubnodeRecord(
    parentNode, // The node/namehash of site.eth
    label, // “my”
    address(this), // The address of the SubnameWrapper
    resolver,
    0, // TTL
    fuses | PARENT_CANNOT_CONTROL | CANNOT_UNWRAP |
CAN_EXTEND_EXPIRY,
    expiry
  );
  subnameWrapper.wrap(node, _name, owner, renewalController,
  expiry);
```

In the call to the NameWrapper ‘setSubnodeRecord’, the fuses ‘PARENT_CANNOT_CONTROL’, ‘CANNOT_UNWRAP’, and ‘CAN_EXTEND_EXPIRY’ are burned. Any name that has those three fuses burned in the NameWrapper smart contract is called a “forever name.”

### Subname Wrapper Contract

Our system is open, permissionless, and composable, allowing anyone to interact with the SubnameWrapper smart contract, create their own renewal controllers and registrars, with the smart contracts deployed to a public blockchain such as Ethereum. At the center of the system is the SubnameWrapper smart contract, which is a singleton, meaning it is only deployed once and all subnames are wrapped using the contract after being wrapped in the ENS NameWrapper smart contract. It is also possible to upgrade the NameWrapper to a newer version in the event of a bug or an upgrade to the code, in a trustless way where the owners of subnames that have been wrapped in the SubnameWrapper smart contract can decide if they want to upgrade their names or not.

The method for upgrading the SubnameWrapper involves the owner or administrator of the SubnameWrapper setting a new upgraded SubnameWrapper contract address in the SubnameWrapper contract. Owners of names can choose to migrate to the new SubnameWrapper contract. In this way, the owner of the SubnameWrapper cannot force names wrapped in the contract to upgrade but can only provide a path to a new upgraded SubnameWrapper contract that names in the SubnameWrapper contract can choose to upgrade to or not. The SubnameWrapper allows parent name owners who wish to rent subnames to create or choose their own registrar contracts as well as create or choose their own renewal controller contracts. With the system, it is possible to have any number of registrar contracts and renewal controllers, and it is also possible for one parent name to use multiple of each to rent subnames, which can be mixed and matched.

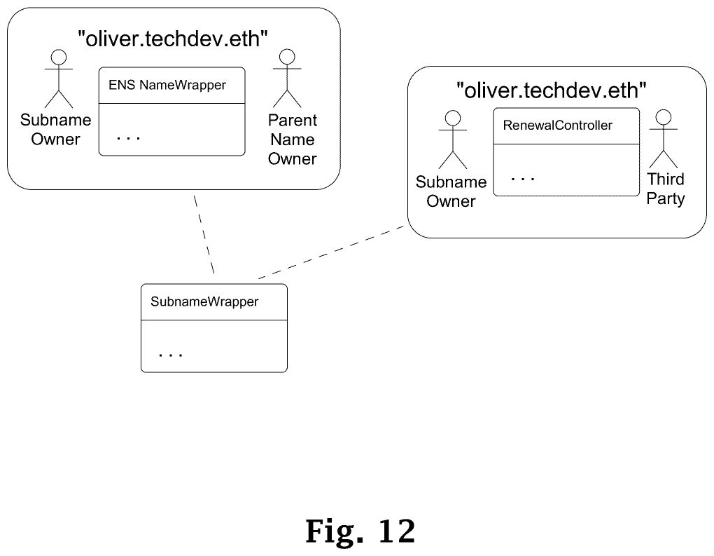

The primary function of the SubnameWrapper is to attach a Renewal Controller to the subname FIG. 12 by wrapping the subname with the address of a Renewal Controller. The renewal controller cannot be removed unless the subname expires, at which point the subname is returned to the parent name owner. It is also necessary to have pass-through functions that allow the owner of a subname to call NameWrapper functions using the SubnameWrapper. These pass-through functions include extendExpiry, setFuses, setChildFuses, setRecord, setSubnodeRecord, setSubnodeOwner, registerAndWrap, setResolver, and setTTL, and can include others as well.

### Renewing a Subname.

To renew a subname wrapped in the Subname Wrapper, it is possible to renew the name before it expires FIG. 8. For example, the owner can send a transaction to the Renewal Controller wrapped with their subname. Specifically, they can call the renew function, or another relevant function, which will in turn call the extendExpiry function of the Subname Wrapper contract. This will then call the extendExpiry function of the ENS NameWrapper contract. In some embodiments of renewal controllers, anyone can renew the name, while in others, only the owner of the subname can renew the name using their private key to sign a transaction.

In cases where a renewal controller is not wrapped with the subname in the Subname Wrapper, the owner of the subname can directly call the extendExpiry function on the Subname Wrapper contract to extend the expiry of the name without any fee except for a gas fee. All transactions, for example on Ethereum, require a gas fee to be paid in ETH.

ENS Profile Hooks with Zero Knowledge Proofs (ZKPs)

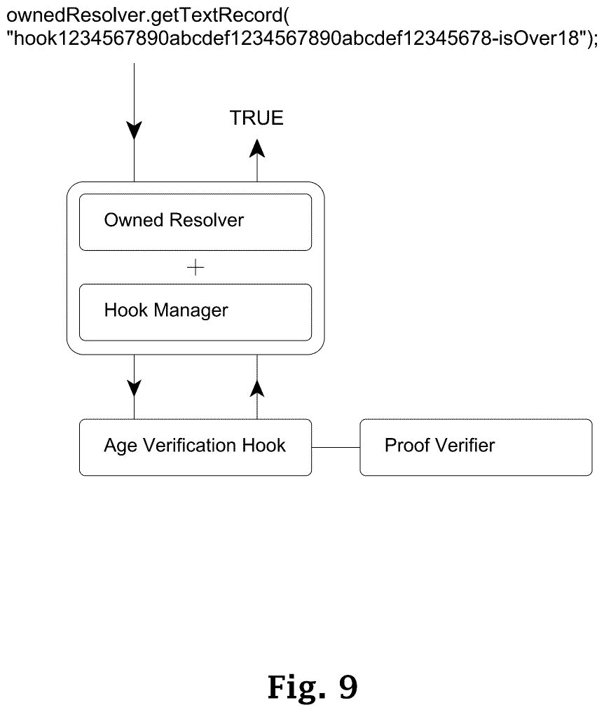

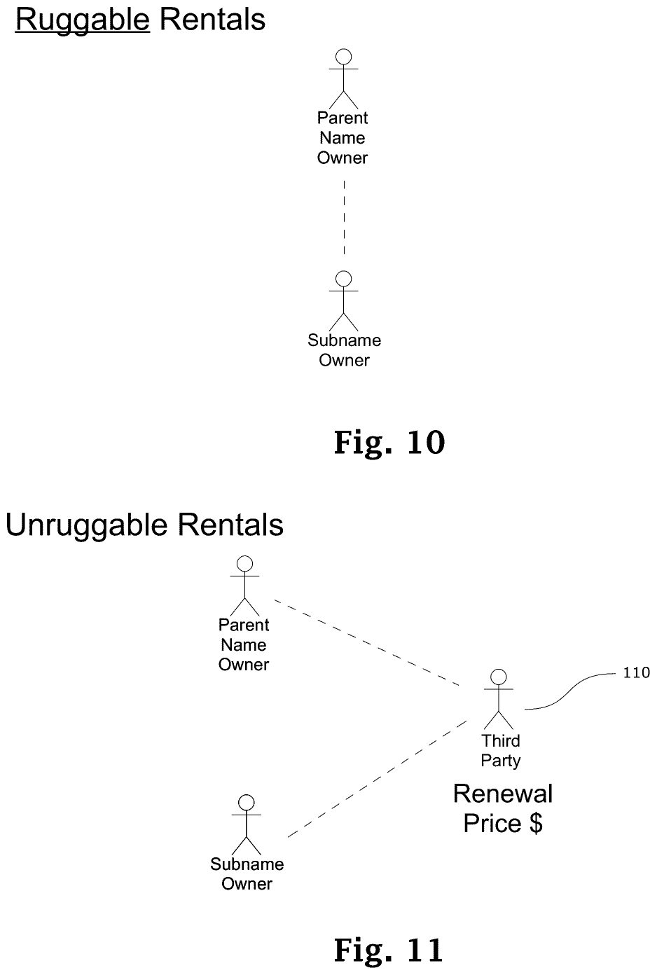

Hooks are a type of mechanism used with smart contracts to extend their capabilities. In the context of ENS, it is possible to use hooks with resolvers FIG. 9, particularly owned resolvers, that act as a profile for an owner. By leveraging Zero Knowledge Proofs (ZKPs) in the form of custom hooks, it is possible to prove certain assertions about a user without revealing the underlying secret data. This section describes how ZKPs can be integrated into an ENS resolver using custom hooks to enhance privacy and security.

In one embodiment, the custom hook implemented on the owned resolver allows users to prove assertions about themselves (e.g., age, nationality) without disclosing the underlying data. The hook stores the facts derived from the proof and necessary metadata, ensuring that third parties can verify the proof's validity without accessing sensitive information.

When a user needs to prove an assertion, the first step involves inputting their custom data into a verified data source maintained by an authority (e.g., a passport or a government database). This verified data source provides signed data confirming the authenticity of the information. Using a ZKVM, the user or the authority generates a Zero Knowledge Proof. The proof process involves compiling the assertion logic into a ZKVM program (e.g., “age >18”), running the ZKVM program with the user's secret data to generate a proof, and generating a receipt that includes the bytecode image of the program, the facts output by the program, and a check to ensure the data is certified as authentically from the authority. This can be done using a storage proof or signature verification against a blockchain state root, database state root, or public key.

The next step is generating a proof that includes the receipt and facts. This proof can contain verification of authority, the bytecode image, and the proof itself. The proof can be generated using any number of computing environments, including cloud computing, on-device computing on the client, GPUs, FPGAs (Field-Programmable Gate Arrays), custom hardware, edge computing devices, Trusted Execution Environments (TEEs), custom ZKVM hardware, and more. The proof must then be submitted for on-chain verification. This verification process ensures the integrity and authenticity of the data. The verifier checks the proof against the bytecode image and authenticated data (e.g., public key, state root). If the verification is successful, the verifier confirms that the facts derived from the proof are accurate and trustworthy. The final step is updating the hook of the owned resolver with the facts that are part of the receipt and proven using the verification step. This ensures that only verified and authenticated information is stored.

Once the proof is verified, the derived facts can be stored in the custom hook on the resolver. The storage structure includes the verified facts derived from the proof (e.g., “age >18”), information necessary to verify the authenticity of the underlying data, such as the verifier's signature, the public key of the authority, or the state root, and the bytecode image hash and other relevant details.

Additionally, it is possible to aggregate many proofs into a single proof to save costs. By combining multiple proofs into one, users can reduce the on-chain verification overhead. This aggregated proof still includes all necessary receipts and facts, ensuring the integrity and authenticity of each individual proof within the aggregation.

For example, the user inputs their custom data (e.g., exact age) into a verified data source maintained by an authority, such as a passport. A proof is generated using a ZKVM. The proof includes generating a receipt that states “age >18” without revealing the actual age. The receipt includes the bytecode image, the facts output by the program, and a verification check using the public key of the authority. The proof, including the receipt, is submitted for verification. The verifier checks the proof against the bytecode image and the public key of the authority that provided the user's age. If the verification passes, the proof and associated facts are stored in the custom hook of the owned resolver.

A third party can retrieve the verified fact and associated metadata from the custom hook and trust the stored facts because they have already been verified. By integrating ZKPs with ENS profiles through custom hooks, users gain greater control over their data, ensuring privacy and security while maintaining the flexibility to prove necessary assertions. This approach leverages the strengths of blockchain technology and cryptographic proofs, providing a robust solution for decentralized identity management.

Detailed Implementation of Owned Resolver with Custom Hook Functionality

In one implementation, Solidity can be used to create an owned resolver that incorporates custom hook functionality FIG. 9. This owned resolver acts as a centralized management point for verifying facts about a user through a flexible and extensible interface. The following describes the detailed design and implementation of such a system, including an interface for hooks, a hook manager contract, an example hook contract, and the owned resolver itself.

### Interface for Hooks

Firstly, an interface is defined that all hook contracts must implement. This interface specifies a function to retrieve the value of a specified key for a user. The implementation of this interface ensures uniformity and compatibility across various hooks.

```
interface IResolverHook {
  function getHookRecord(string calldata key) external view returns
  (string memory);
  function setHookData(bytes calldata data) external;
}
```

### Hook Manager Contract

The hook manager contract is responsible for managing the hooks and retrieving records based on the text record key. This contract stores valid hook addresses and provides functions to add and remove hooks. Additionally, it includes a function to get records by parsing the text record key and querying the appropriate hook contract.

```
import “./IResolverHook.sol”;
contract HookManager {
  mapping(address => bool) public hooks; // Store valid hook
addresses
  // Add a new hook
  function addHook(address hook) public {
    hooks[hook] = true;
  }
  // Remove a hook
  function removeHook(address hook) public {
    hooks[hook] = false;
  }
  // Set data in the hook generically using bytes
  function setHookData(address hook, bytes calldata data) public {
    // Check if the hook is valid
    require(hooks[hook], “Invalid hook”);
    // Call the hook to set the data
    IResolverHook(hook).setHookData(data);
  }
  // Get a record based on the text record key
  function getParsedRecord(string calldata textRecordKey) public view
returns (string memory) {
    // Split the text record key into the hook address and the fact
    (address hook, string memory key) =
parseTextRecordKey(textRecordKey);
    // Check if the hook is valid
    require(hooks[hook], “Invalid hook”);
    // Call the hook to get the fact
    return IResolverHook(hook).getHookRecord(key);
  }
  // Utility function to parse the text record key
  function parseTextRecordKey(string memory textRecordKey) internal
pure returns (address, string memory) {
    // parse code goes here -->
    return (hook, key);
  }
  // Utility function to parse a string into an address
  function parseAddress(string memory _a) internal pure returns
(address) {
    //parse code goes here -->
    return address(iaddr);
  }
}
```

### Example Hook Contract

An example hook contract implements the IResolverHook interface. This contract stores user facts as key-value pairs and provides a function to retrieve these facts. The hook is responsible for storing and returning facts such as “isOver18”. Additionally, the contract includes a constructor to set the Proof Verifier contract and a verifyProof function to set the isOver18 variable for the user.

```
pragma solidity \hat{ }0.8.0;
import “./IResolverHook.sol”;
interface IProofVerifier {
  function verify(bytes calldata proof) external returns (bool);
}
contract AgeVerificationHook is IResolverHook {
  struct UserFacts {
    string isOver18;
  }
  UserFacts public userFacts ;
  IProofVerifier public proofVerifier;
  // Constructor to set the Proof Verifier contract
  constructor(address verifierAddress) {
    proofVerifier = IProofVerifier(verifierAddress);
  }
  // Function to set data generically using bytes
  // In this case verify the proof.
  function setHookData(bytes calldata data) external override {
    require(proofVerifier.verify(data), “Invalid proof”);
    // Decode the data and set the user facts
    (string memory fact) = abi.decode(data, (string));
    userFacts[msg.sender].isOver18 = fact;
  }
  // Function to get the fact
  function getHookRecord(string calldata key) external view override
returns (string memory) {
    if (keccak256(abi.encodePacked(key)) ==
keccak256(abi.encodePacked(“isOver18”))) {
      return userFacts.isOver18;
    }
    return “UNKNOWN”;
  }
}
```

### Owned Resolver Acting as Hook Manager

The owned resolver integrates the functionality of the hook manager. It overrides the getTextRecord function to check if the requested key is a hook key and, if so, uses the hook to retrieve the corresponding value.

```
pragma solidity \hat{ }0.8.0;
import “./HookManager.sol”;
contract OwnedResolver is HookManager {
  mapping(string => string) public textRecords; // Store regular text
records
  // Set a text record
  function setTextRecord(string calldata key, string calldata value)
external {
    textRecords[key] = value;
  }
// Override the function to handle hook text key value requests
  function getTextRecord(string calldata key) external view returns
(string memory) {
  // Check if the key follows the hook format (hook<address>-<key>)
    if (isHookKey(key)) {
      return getParsedRecord(key);
    }
    // Otherwise, return the regular text record
    return textRecords[key];
  }
  // Utility function to check if the key follows the hook format
  function isHookKey(string memory key) internal pure returns (bool){
    // If “hook” at the beginning and “-” separator
    return // if the format is correct
  }
}
```

### Usage

To use the OwnedResolver, Hook Manager, and Hook contracts, you first deploy the OwnedResolver contract and the AgeVerificationHook contract with the address of the Proof Verifier contract. Then, you add the hook to the resolver, set the hook data, and retrieve records. For example, assuming OwnedResolver, AgeVerificationHook, and ProofVerifier are already deployed: add the hook to the OwnedResolver, set the hook data, retrieve the fact using the text record key format FIG. 9, and retrieve a regular text record.

// Assuming OwnedResolver, AgeVerificationHook, and ProofVerifier are
already deployed
// Add the hook to the OwnedResolver
ownedResolver.addHook(address(ageVerificationHook));
// Set the hook data (this would typically be done after generating the
proof off-chain and obtaining the proof data)
ownedResolver.setHookData(address(ageVerificationHook), proofData);
// Retrieve the fact using the text record key format
string memory isVerified = ownedResolver.getTextRecord(
“hook1234567890abcdef1234567890abcdef12345678-isOver18”);
// Retrieve a regular text record
string memory regularValue = ownedResolver.getTextRecord(
“regularKey”);

This setup provides a flexible way to manage and verify various user facts through a standardized interface, leveraging the extensibility of hooks and the power of ZKPs.

Hooks are fully programmable and customizable. For example, it is possible to make a follower hook that allows one resolver to follow other resolvers, ENS names, or blockchain accounts. Other hooks could allow for attestations made about the user, such as KYC/AML compliance, certified investor status, or any other financial identifiers that can be attributed to the owner of the resolver. It is also possible to create hooks for ticket management, enabling the resolver to store and verify event tickets or access passes.

A hook could be created to allow for offchain write capabilities, wherein a client first checks the resolver before being directed to an API or a different blockchain to write the data. This could be used in the case where the resolver is an offchain resolver used to resolve subnames offchain.

In addition to these, hooks can be designed to manage social interactions, like integrating with social media profiles or verifying membership in specific organizations. For instance, a resolver could include a hook that verifies the user's membership in a professional organization or a social club, providing a level of trust and verification for interactions on the blockchain.

Another potential application is for academic credentials. A resolver hook could be used to verify educational qualifications, certifications, and other academic achievements, enabling users to prove their credentials without revealing sensitive information. This could be particularly useful in job applications or professional networking scenarios.

### INTERPRETATION AND SCOPE OF THE INVENTION

The embodiments described herein are merely illustrative and should not be construed to limit the scope of the invention or the claims. Throughout the specification, terms such as “comprising,” “including,” “having,” and their derivatives, as used herein, are synonymous and are intended to be inclusive and open-ended.

The singular forms “a,” “an,” and “the” include plural referents, unless the context clearly dictates otherwise. Additionally, terms such as “first,” “second,” “upper,” “lower,” “inner,” “outer,” and the like may be used to describe various elements, but such terms are not intended to impose any particular ordering or hierarchy unless expressly stated.

The invention can be implemented in various forms, including systems and methods, using hardware, software, firmware, or combinations thereof. The description provided herein contemplates the utilization of computational resources, such as computers, processors, and networks, to carry out the disclosed functionalities.

### Definition of Terms

For the purposes of this patent application, the term “blockchain” refers to a distributed ledger system that maintains a continuously growing list of records, called blocks, which are linked and secured using cryptographic techniques. It is typically operated within a decentralized network of computers, often referred to as nodes, and provides immutability, transparency, and security for recorded data.

The term “computer” encompasses any device capable of processing and executing instructions, including but not limited to personal computers, servers, mobile devices, embedded systems, and other electronic devices.

The term “memory” refers to any form of volatile or non-volatile storage medium capable of storing data, instructions, or other digital information. This can include, but is not limited to, random access memory (RAM), read-only memory (ROM), flash memory, magnetic storage devices, optical storage devices, and solid-state drives (SSDs).

The term “software” refers to a set of instructions or programs that are executed by a computer or other processing device to perform specific tasks or functions. In the context of the disclosed systems and methods, the software facilitates the renting of subnames and the associated payment processing.

1. A method for registering and renewing one or more subnames of a parent name using renewal controllers, comprising:
receiving a request to register a subname;
determining the registration cost using the duration and price for registering the subname;
assigning a renewal controller to the subname for future renewals;
registering the subname; and
renewing the subname that includes the steps of:
determining the renewal controller of the subname;
determining the cost using the duration and price for renewing the subname, using the renewal controller of the subname; and
making payment of the cost.

2. The method of claim 1, further comprising:
resolving the subname using a resolver comprising a hook used to resolve verified facts, which are proven using ZKPs.

3. The method of claim 1, wherein the possible registration maximum and minimum duration can be set by the parent name owner.

4. The method of claim 1, wherein the cost of subname registration and renewal can be paid using cryptocurrencies or tokens.

5. The method of claim 1, wherein a voucher system is used to allow gifting or airdropping of subnames without payment of additional fees other than gas fees.

6. The method of claim 1, wherein a Merkle tree is used to verify eligibility for registering a subname.

7. The method of claim 1, further comprising the creation of a smart account comprising a subname using a single blockchain transaction.

8. The method of claim 1, wherein the subname is wrapped in a smart contract comprising renewal controllers.

9. A system for renting one or more subnames of a parent name using renewal controllers, comprising:
a user interface for requesting and managing subname rentals;
a subname registrar for registering subnames and setting registration parameters;
a renewal controller for determining renewal prices and managing subname renewals; and
a smart contract used to assign the subnames to renewal controllers, wherein each subname may be renewed using the assigned renewal controller and the owner of the parent name cannot unassign the renewal controller of the subname.

10. The system of claim 9, wherein the user interface comprises at least one of a Dapp, chatbot, audio interface, VR/AR/XR app, or virtual assistant application.

11. The system of claim 9, wherein the subname registrar is approved by the parent name owner to register subnames and wherein the registration parameters include one or more renewal controllers which are used to assign renewal controllers to subnames.

12. The system of claim 9, wherein renewal controllers are controlled by a third-party organization or a group of guardians.

13. The system of claim 9, wherein the renewal controllers include an oracle for obtaining off-chain data, such as renewal prices.

14. The system of claim 9, further comprising multi-signature wallets for collectively controlling the renewal controllers.

15. The system of claim 9, wherein the smart contract used to wrap the subnames with renewal controllers is an NFT contract.

16. The system of claim 9, further comprising:
resolving the subnames using at least one of a resolver comprising a hook used to resolve verified facts, which are proven using ZKPs.

17. The system of claim 9, wherein the user interface allows users to choose a rental duration and select payment options.

18. The system of claim 9, wherein the smart contract used to assign subnames to renewal controllers is integrated with at least one of smart wallets and smart accounts, wherein a subname and smart account or smart wallet can be registered using a single blockchain transaction.

19. The system of claim 9, wherein the subname is used as the name of a blockchain-based user profile used for one or more of social media apps, wallet apps, Dapps, metaverse apps, and smartphone profiles, including phone-to-phone profile sharing.

20. The system of claim 9, wherein the subname is resolved using a resolver that comprises hooks, including a followers hook that comprises a list of other profiles, wallet addresses, or ENS names that are followed by the name owner.
